(19) United States
(12) Patent Application Publication
(10) Pub. No.: US 2008/0007768 A1
(43) Pub. Date: Jan. 10, 2008

(54) Network device, network manager, network managing system, and method of performing clone process

(75) Inventor: Jae-kyung Cho, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/647,234

(22) Filed: Dec. 29, 2006

(30) Foreign Application Priority Data
Jun. 30, 2006 (KR) 2006-60464

(51) Int. Cl. G06F 3/12

(52) U.S. Cl. 358/1.15

(57) ABSTRACT

A network device, a network manager, a network managing system, and a method of performing a clone process are provided, which can facilitate the determination of the progress of a clone process, reduce the load of a manager, and improve data transmission on a network. The network device includes a storage unit storing clone data and position information of a network manager, a control unit for performing a clone process on the basis of the clone data and generating status report data of the clone process that corresponds to the progress of the clone process, and a transmission unit for transmitting the generated status report data of the clone process to the network manager using the position information of the network manager.

### CROSS-REFERENCE TO RELATED APPLICATIONS

This application claims the benefit of Korean Patent Application No. 2006-60464, filed Jun. 30, 2006 in the Korean Intellectual Property Office, the entire disclosure of which is incorporated herein by reference.

### BACKGROUND OF THE INVENTION

1. Field of the Invention

Aspects of the present invention relate to a network device, a network manager, a network managing system, and a method of performing a clone process. More particularly, aspects of the present invention relates to a network device, a network manager, a network managing system, and a method of performing a clone process, which can facilitate the determination of the progress of a clone process, reduce a load of a manager, and improve data transmission on a network.

2. Description of the Related Art

In order to change setting information with respect to a plurality of devices connected to each other through a network, a user should set respective setting information. That is, even if a large number of devices exist, the user should access the setting information of the respective devices one by one and separately set them.

If classification of the setting information of the devices connected to each other through the network is identical to each other and a setting value to be set with respect to the respective devices is identical to each other, i.e., the user intends to change the setting information of all the devices to the same value, he/she should access the devices separately and set the setting information of the devices connected through the network one by one, and this would require a lot of effort and time.

In this case, a method of changing the setting information of a specified device, receiving related data, and then changing the setting information of other devices on the basis of the received data, may be used, instead of separately changing the setting information of the plural devices. This method is called a “clone process.” That is, data of a specified device is cloned and copied to other devices as clone data, and the setting information of the devices is changed on the basis of the clone data.

In order to proceed with the clone process, a network manager requests clone data from a specified network device. The device that provides the clone data generates the clone data for its own setting information and transmits the generated clone data to the network manager having requested the clone data. The network manager receives and transmits the clone data to the device that intends to change its setting information.

In the event that plural network devices exist, the network manager successively transmits the clone data to the respective network devices. The network device may request status information corresponding to the progress of the clone process on the network device after it transmits the clone data to the corresponding network device. If the network device having received the clone data receives the request for status information from the network manager, it transmits the status information corresponding to the proceeding of the clone process to the network manager, so that the network manager can determine the present status of the network device.

However, if the network device having received the request for the status information is disconnected from the network or the operation of the network device is not normal, the network device cannot respond to the request, and thus the network manager cannot determine to what extent the clone process has progressed in the network device.

Even if the network device operates normally, the network manager should request the status information with respect to a large number of network devices. Accordingly, in the case of successively proceeding with a clone process for multiple network devices, it takes a lot of time to perform the clone process since the network manager repeats the request for status information with respect to each of the network devices. This causes the load of the network manager to be increased in transmitting/receiving data in the network.

In addition, information on the proceeding of the clone process for the devices connected to the network can be acquired only by the network manager's request for the status information, and thus it is not easy to determine the whole proceeding status of the clone process that is successively performed.

### SUMMARY OF THE INVENTION

Embodiments of the present invention have been developed in order to substantially solve the above and for other problems associated with the conventional arrangement. Aspects of present invention provide a network device, a network manager, a network managing system, and a method of performing a clone process, which can facilitate the determination of progress of a clone process, reduce the load of a manager, and improve data transmission on a network.

According to an aspect of the present invention, a network device is provided, which comprises a storage unit storing clone data and position information of a network manager, a control unit to perform a clone process based on the clone data and generating status report data of the clone process that corresponds to the progress of the clone process, and a transmission unit to transmit the generated status report data of the clone process to the network manager using the position information of the network manager.

According to other aspects of the present invention, the clone data may be setting information of the network device including at least one of a printing mode, the number of copy sheets, and resolution.

According to another aspect of the present invention, if the clone process is completed, the control unit may generate completion report data indicating that the clone process is completed, and transmit the completion report data to the network manager.

According to another aspect of the present invention, if the completion report data is transmitted to the network manager, the control unit may delete the position information from the storage unit.

According to another aspect of the present invention, the transmission unit transmits the generated status report data of the clone process to the network manager for each phase of the clone process.

According to another aspect of the present invention, there is provided a network manager, which comprises a storage unit storing position information of the network manager, and a control unit requesting clone data from a first network device, and if the clone data is received, adding the position information of the network manager to the received clone data to transmit the combined clone data and position information to at least one second network device.

According to another aspect of the present invention, if the control unit receives from the second network device status report data relating to progress of a clone process corresponding to the clone data, the control unit may store the status report data in the storage unit.

According to another aspect of the present invention, if the control unit receives from the second network device completion report data indicating that the clone process performed on the basis of the clone data is completed the control unit may store the completion report data in the storage unit.

According to another aspect of the present invention, there is provided a network device management system which comprises a plurality of network devices, and a network manager requesting clone data from a first network device of the plurality of network devices, and if the clone data is received from the first network device in response to the request, adding position information of the network manager to the received clone data to transmit the combined clone data and position information to at least one second network device among the plurality of network devices.

According to another aspect of the present invention, the second network device may include a storage unit storing clone data and position information of the network manager, a control unit performing a clone process based on the clone data and generating status report data of the clone process that corresponds to the progress of the clone process, and a transmission unit for transmitting the generated status report data of the clone process to the network manager using the position information of the network manager.

According to another aspect of the present invention, there is provided a method of performing a clone process of a network device which comprises storing clone data and position information of a network manager, performing the clone process on the basis of the clone data, generating status report data of the clone process that corresponds to progress of the clone process, and transmitting the generated status report data of the clone process to the network manager using the position information of the network manager.

According to another aspect of the present invention, the method may further comprise judging validity of the clone data and generating and transmitting an error message to the network manager if the clone data is not valid.

According to another aspect of the present invention, the method may further comprise generating completion report data if the clone process is completed indicating that the process is completed, and transmitting the completion report data to the network manager. Further, if the completion report data is transmitted to the network manager, the method may further comprise deleting the position information from the storage unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a functional block diagram of a network device according to an embodiment of the present invention;

FIG. 2 is a functional block diagram of a network system including a network device and a network manager according to an embodiment of the present invention;

FIG. 3 is a view schematically illustrating the transmission of status report data from a network device to a network manager in a network system according to an embodiment of the present invention; and

FIG. 4 is a flowchart illustrating a method of performing a clone process according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

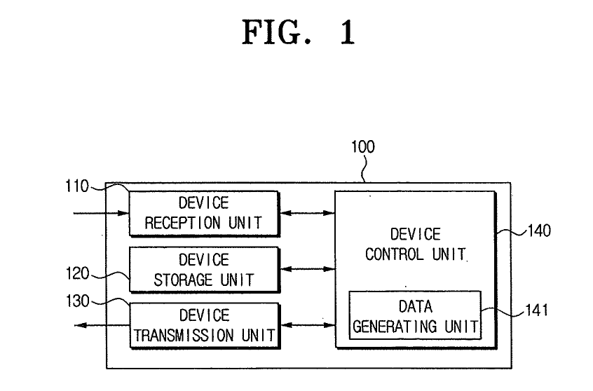

FIG. 1 is a functional block diagram of a network device 100 according to an embodiment of the present invention.

The network device 100 according to a first embodiment of the present invention includes a device reception unit 110, a device storage unit 120, a device transmission unit 130, and a device control unit 140. The device control unit 140 may include a data generating unit 141. According to other aspects of the present invention, the units may be subcomponents of a larger unit; for example, the device reception unit 110 and the device transmission unit 130 may be subcomponents of a larger device reception/transmission unit.

The device reception unit 110 receives data and diverse information that is transmitted to the network device 100. The device reception unit 110 according to embodiments of the present invention can receive clone data transmitted from a network manager (not shown) and position information of the network manager contained in the clone data. The device reception unit 110 may be provided in a network communication interface interfacing the network device 100 to a network.

The device storage unit 120 is a storage medium storing data and diverse programs required to drive the network device 100. Further, the device storage unit 120 stores data and diverse information received from the device reception unit 110.

The device storage unit 120 according to the first embodiment of the present invention stores the clone data necessary for the network device 100 and the position information of the network manager. Further, the device storage 120 stores the generated status information data that corresponds to the proceeding of the clone process, and completion report data generated when the clone process is completed.

The term clone data in this instance refers to setting information, in which the network device 100 performs the clone process on the basis of the setting information. The clone data may be setting information of the network device 100. For example, if the network device is a printer, the setting information may comprise a printing mode (double-sided copying or single-sided copying), the number of copy sheets (1 to 999 sheets), the resolution (for example, 1022 dpi), and other setting information on image formation. Different types of network devices will have different settings. The generation and transmission/reception of the clone data will be described hereinafter. Other aspects of the present invention may use other types of data.

The position information of the network manager may be the location of the network manager on the network. For example, the position information may be an IP address. In this embodiment of the present invention, the position information may be used as location information so that the network device 100 properly transmits the status information data to the correct network manager. Other aspects of the present invention may use different kinds of location information, such as a MAC address.

The device control unit 140 generally controls the operation of the network device 100. Specifically, the device control unit 140 performs the clone process on the basis of the clone data. The device control unit 140 may include a data generating unit 141. According to other aspects of the present invention, the data generating unit 141 may be a separate unit within the network device 100.

The data generating unit 141 generates status report data of the clone process corresponding to the proceeding for each phase, if the clone process is performed at several phases. Alternatively, the data generating unit 141 may generate status report data for a specified time interval, if the clone process is not performed at several phases. According to other aspects of the present invention, the data generating unit 141 need not generate status report data for each phase; the data generating unit 141 may instead generate status report data for some phases, such as critical phases of the clone process or phases selected by a network administrator as requiring generation of status report data. The data generation unit 141 may also generate an error message if it determines that the clone data is invalid.

If status report data is generated, the device control unit 140 commands the device transmission unit 130 to transmit the status report data to the position of the network manager by referring to the position information of the network manager stored in the device storage unit 120.

If the clone process is completed, the data generating unit 141 may generate the completion report data indicating that the process is completed. If the completion report data is generated, the device control unit 140 may command the device transmission unit 130 to transmit the completion report data to the network manager.

Further, if the completion report data is transmitted to the network manager, the device control unit 140 deletes the position information from the storage unit. The storage capacity of the device storage unit 120 of the network device 100 is generally finite. Consequently, when the clone process is completed, the device control unit 140 can delete the position information, as there is little chance the position information will be used to transmit the status report data again, so as to effectively utilize the device storage unit 120. However, according to other aspects of the present invention, the device storage unit 120 may retain the position information, such as when the clone process is likely to run again but the position information is not likely to be changed.

The device transmission unit 130 transmits data and diverse information from the device to other devices or to the network manager.

The device transmission unit 130 according to the first embodiment of the present invention transmits the status report data of the clone process generated by the device control unit 140 to the network manager by use of the position information of the network manager. Specifically, the transmission unit 130 transmits the status report data of the clone process generated for each phase of the clone process to the network manager for each processing phase. According to other aspects of the present invention, the transmission unit 130 will only transmit status report data for some phases of the clone process. The transmission unit may also transmit error messages.

The device transmission unit 130 may be provided in a network communication interface (not shown) interfacing the network device 100 to the network.

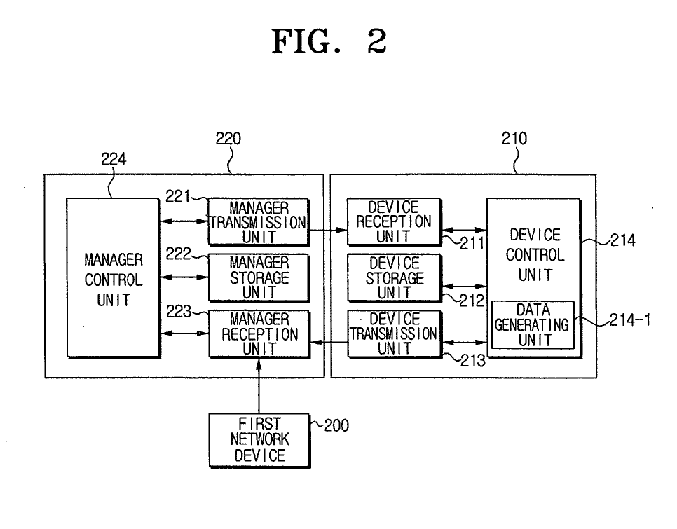

FIG. 2 is a functional block diagram of a network system including a first network device 200, a second network device 210 and a network manager 220 according to a second embodiment of the present invention.

If a first network device 200 receives a request for the clone data from the network manager 220, the first network device 200 generates and transmits the clone data to the network manager 220.

The second network device 210 includes a device reception unit 211, a device storage unit 212, a device transmission unit 213, and a device control unit 214. The device control unit 214 may have a data generating unit 214-1. According to other aspects of the present invention, the data generating unit 214-1 may be a separate unit within second network device 210 and not a subcomponent of device control unit 214. In addition, some units may be subcomponents of a single larger unit; for example, the device reception unit 211 and the device transmission unit 213 may be subcomponents of a single device transmission/reception unit. Functions of the above units are identical to those shown and described in FIG. 1.

The network manager 220 has a network manager transmission unit 221, a network manager storage unit 222, a network manager reception unit 223, and a network manager control unit 224.

The network manager transmission unit 221 transmits data and diverse information to a device or other network manager. The network manager transmission unit 221 according to the second embodiment of the present invention transmits the clone data generated by the first network device 200 to the second network device 210.

The network manager storage unit 222 stores data and diverse information received via the network manager reception unit 223, as well as information on the clone data and the status report data, the completion report data, and error messages. Further, the network manager storage unit 222 stores the position information of the network manager 220.

The position information of the network manager 220 may be information on the location of the network manager 220 on the network. For example, the position information may be an IP address. Other aspects of the present invention may use different kinds of location information, such as a MAC address.

The network manager reception unit 223 receives the data and diverse information that are transmitted to the network manager 220. The network manager reception unit 223 according to the second embodiment of the present invention receives clone data from the first network device 200. Further, the network manager reception unit 223 receives status report data, completion report data, and error messages from the second network device 210.

The network manager control unit 224 generally controls the operation of the network manager 220. The network manager control unit 224 according to the second embodiment of the present invention requests the clone data from the first network device 200.

If the network manager control unit 224 receives the clone data in response to the request of the first network device 200, the network manager control unit 224 adds information on the position of the network manager to the clone data, and sequentially transmits the clone data and position information to at least one second network device among plural network devices.

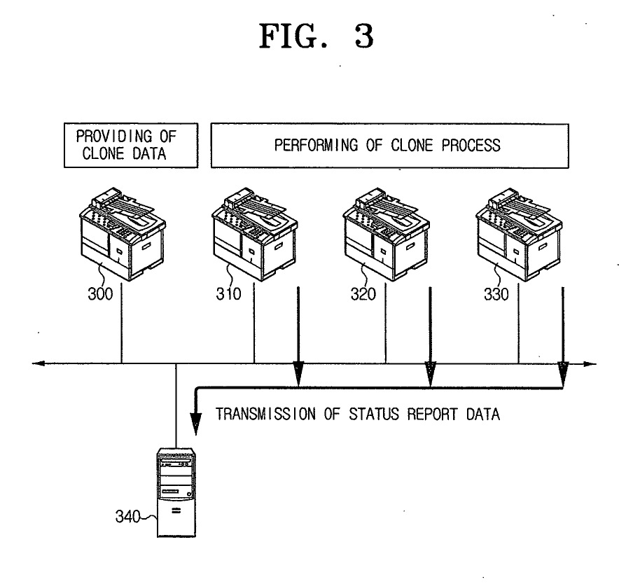

FIG. 3 is a view schematically illustrating the transmission of status report data from the network device to the network manager in the network system according to a third embodiment of the present invention.

The first network device 300 provides the clone data. The clone data is generated by the first network device in response to the request of the network manager 340, and is transmitted to the network manager 340.

The network manager 340 receives the clone data and transmits the clone data to network devices 310, 320 and 330. Three devices performing the clone process are shown in this embodiment, but according to other aspects of the present invention there can be two, three, or more devices.

The network devices 310, 320, and 330 receive the clone data and perform the clone process on the basis of the clone data. The status report data is generated at each phase of the clone process. Each of the network devices 310, 320, and 330 transmits the status report data to the network manager 340. According to other aspects of the present invention, status report data is generated only for some phases of the clone process. If the network devices 310, 320, and 330 determine the clone data to be invalid, the network devices 310, 320, and 330 transmit an error message to the network manager 220.

The network manager 340 receives and stores the status report data, receives and stores error messages, and manages the progress of the clone process in the network management system.

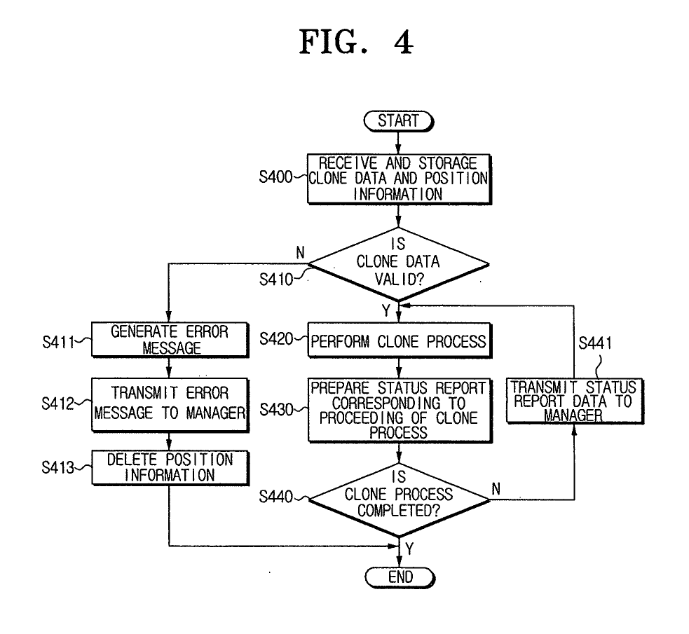

FIG. 4 is a flowchart illustrating a method of performing the clone process according to a fourth embodiment of the present invention.

The network device receives and stores the clone data and the position information at (S400).

The network device judges validity of the clone data at (S410). The network device may determine that the clone data is not valid; in these cases the network device does not perform the clone process on the basis of the clone data. For example, coding may not be possible in the network device performing the clone process due to an error of the clone data file or an error in encoding of the clone data, or compressed data may not be decompressed. The network device may determine that the clone data is invalid for any other reason as well.

If the network device judges that the clone data is valid (“Yes” at (S410)), the network device performs the clone process at (S420). In this case, the network generates the status report data corresponding to the progress of the clone process at (S430). For example, the progress may include analyzing the clone data, judging whether the clone data is valid, storing the clone data, and changing the setting information on the basis of the clone data. Preferably, the generated status report data of the clone process is transmitted to the network manager for each phase. According to other aspects of the present invention, status report data is transmitted to the network manager only for some phases.

If the status report data is generated, the network device judges whether the clone process is completed at (S440).

If it is judged that the clone process is not completed (“No” at (S440)), the network device transmits the generated status report data to the network manager at (S441). After the status report data is transmitted, the progress of the clone process is repeated at (S420 to S440).

If it is judged that the clone process is completed (“Yes” at (S440)), the progress of the clone process is terminated.

In judging the validity of the clone data, the network device generates an error message at (S411) if the clone data is not valid (“No” at (S410)).

The generated error message is transmitted to the network manager at (S412), and the information on the position of the network manager that is not necessary is deleted from the storage unit at (S413). According to other aspects of the present invention, the network device may retain the position information of the network manager.

As described above, according to various embodiments of the present invention, such as the network device, the network manager, the network managing system including them, and the method of performing the clone process, when the clone process is performed in the network device, the status report data is automatically generated, and is transmitted to the network manager transmitting the clone data, which can facilitate the determination of the progress of the clone process.

Further, the load applied to the network manager by continuously requesting the status information to determine the progress of the clone process is reduced, and unnecessary and repeated requests for the status information are reduced as well. Therefore, data transmission on the network is improved. In addition, since any errors in the progress of the clone process are accurately captured, the clone process progresses more effectively.

The invention can also be embodied as computer readable instruction codes on a computer readable recording medium. The computer readable recording medium is any data storage device able to store data that can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed network coupled computer systems so that the computer readable code is stored and executed in a distributed fashion.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A network device comprising:
a storage unit storing clone data and position information of a network manager;
a control unit to perform a clone process based on the clone data and to generate status report data of the clone process that corresponds to progress of the clone process; and
a transmission unit to transmit the generated status report data of the clone process to the network manager using the position information of the network manager.

2. The network device according to claim 1, wherein the clone data is setting information including at least one of a printing mode, the number of copy sheets, and resolution.

3. The network device according to claim 1, wherein if the clone process is completed, the control unit generates completion report data indicating that the clone process is completed, and transmits the completion report data to the network manager.

4. The network device according to claim 1, wherein if the completion report data is transmitted to the network manager, the control unit deletes the position information from the storage unit.

5. The network device according to claim 1, wherein the transmission unit transmits the generated status report data of the clone process to the network manager for each phase of the clone process.

6. A network manager comprising:
a storage unit storing position information of the network manager; and
a control unit requesting clone data from a first network device, and if the clone data is received, adding the position information of the network manager to the received clone data to transmit the combined clone data and position information to at least one second network device.

7. The network manager according to claim 6, wherein if the control unit receives from the second network device status report data relating to the progress of a clone process corresponding to the clone data, the control unit stores the status report data in the storage unit.

8. The network manager according to claim 6, wherein if the control unit receives from the second network device completion report data indicating that the clone process performed on the basis of the clone data is completed, the control unit stores the completion report data in the storage unit.

9. A network device management system comprising:
a plurality of network devices; and
a network manager requesting clone data from a first network device among the plurality of network devices, and if the clone data is received from the first network device in response to the request, adding position information of the network manager to the received clone data and transmitting the combined clone data and position information to at least one second network device among the plurality of network devices.

10. The network device management system according to claim 9, wherein the second network device comprises:
a storage unit storing the clone data and the position information of the network manager;
a control unit performing a clone process based on the clone data and generating status report data of the clone process that corresponds to the progress of the clone process; and
a transmission unit transmitting the generated status report data of the clone process to the network manager using the position information of the network manager.

11. A method of performing a clone process of a network device, the method comprising:
storing clone data and position information of a network manager;
performing a clone process based on the clone data;
generating status report data of the clone process that corresponds to the progress of the clone process; and
transmitting the generated status report data of the clone process to the network manager using the position information of the network manager.

12. The method according to claim 11, further comprising:
judging validity of the clone data; and
generating and transmitting an error message to the network manager if the clone data is not valid.

13. The method according to claim 11, wherein the transmitting of the status report data of the clone process to the network manager comprises transmitting the generated status report data of the clone process to the network manager for each clone process phase.

14. The method according to claim 11, further comprising generating completion report data if the clone process is completed indicating that the process is completed, and transmitting the completion report data to the network manager.

15. The method according to claim 14, further comprising deleting the position information from the storage unit if the completion report data is transmitted to the network manager.

16. The network device according to claim 1, wherein the transmission unit transmits the generated status report data of the clone process to the network manager for at least one phase of the clone process.

17. The network device according to claim 1, further comprising a reception unit to receive a request from the network manager.

18. The network device according to claim 17, wherein the request comprises a request for the clone data.

19. The network device according to claim 17, wherein the request comprises clone data, position information, and a request to begin a clone process.

20. The network device according to claim 1, wherein the control unit judges the validity of the clone data received from the network manager.

21. The network device according to claim 20, wherein if the control unit judges the clone data to be invalid, the control unit generates an error message and transmits the error message to the network manager.

22. The method according to claim 11, wherein the transmitting of the generated status report data of the clone process to the network manager comprises transmitting the generated status report data of the clone process to the network manager for at least one clone process phase.

23. The network manager according to claim 6, wherein if the control unit receives an error message indicating that the second network device failed to complete the clone process, the control unit stores the error message in the storage unit.

24. The network manager according to claim 6, further comprising a manager transmission unit by which the control unit requests the clone data from the first network device and transmits the clone data and the position information to the second network device.

25. The network manager according to claim 6, further comprising a manager reception unit to receive the clone data from the first network device and to receiving the status report data, the completion report data, and the error messages from the second network device.

26. A computer readable recordable medium encoded with instructions to perform a method comprising:
transmitting a request for clone data to a first network device;
transmitting clone data received from the first network device, along with position information of a network manager, to at least one second network device;
receiving from the at least one second network device status report data of the clone process that corresponds to the progress of the clone process, completion report data indicating that the clone process is completed, or error messages; and
storing the status report data, completion report data, or error messages received from the at least one second network device.

27. A computer readable recordable medium encoded with instructions to perform a method comprising:
storing clone data and position information of a network manager;
performing a clone process on the basis of the clone data;
generating status report data of the clone process that corresponds to the progress of the clone process; and
transmitting the generated status report data of the clone process to the network manager using the position information of the network manager.

28. The method according to claim 12, further comprising deleting the position information from the storage unit if the clone data is not valid.

29. A system to reduce load on a network manager, comprising:
a plurality of network devices, wherein one of the plurality of network devices copies clone data for a clone process to the other network devices of the plurality of network devices;
a network manager;
wherein the network devices automatically transmit to the network manager status report information corresponding to progress of the clone process.
